(19) United States
(12) Patent Application Publication
(10) Pub. No.: US 2006/0149618 A1
(43) Pub. Date: Jul. 6, 2006

(54) System for providing private offers to customers of web sites

(76) Inventors: Michael Balin, Tel-Aviv (IL); Yoram Kornatzky, Tel-Aviv (IL)

Correspondence Address: DANIEL J SWIRSKY, 55 REUVEN ST., BEIT SHEMESH, 99544, IL

(21) Appl. No.: 10/545,688

(22) PCT Filed: Feb. 19, 2004
(86) PCT No.: PCT/IL04/00165

§ 371 Date: Aug. 15, 2005

Related U.S. Application Data
(60) Provisional application No. 60/447,698, filed on Feb. 19, 2003.

(51) Int. Cl. G06Q 30/00

(52) U.S. Cl. 705/14

(57) ABSTRACT

A method for creating private offers including parsing at least a first computer-based document to identify at least one offer for either of a product and a service, maintaining the offer in a history of offers, detecting the activation of a private offer element within a second computer-based document, the private offer element being associated with either of a product and a service, determining, responsive to the activation, whether any of the offers in the history of offers meets at least one predefined criterion in predefined association with the private offer element, and applying at least one predefined modification to any of the offers in the history of meeting the predefined criterion, thereby resulting in a private offer.

### CROSS-REFERENCE TO RELATED APPLICATIONS

This application claims the benefit of U.S. Provisional Patent Application Ser. No. 60/447,698, filed Feb. 19, 2003, entitled “System for providing private offers for products or services to customers of E-Commerce web sites based on their individual history of browsing,” and incorporated herein by reference in its entirety.

### FIELD OF THE INVENTION

The present invention relates to electronic commerce (E-Commerce) in general, and more particularly to the pricing of products and services offered on a web site.

### BACKGROUND OF THE INVENTION

The Internet has become a key medium for commercial interaction. Internet vendors, such as amazon.com®, service enormous numbers of customers who purchase products and services much as they would at a ‘brick and mortar’ store.

Special offers and reductions, such as sales and coupons, are one of the techniques employed by vendors, both Internet and ‘brick and mortar’, to attract customers. Typically, the special offers are either product-based or customer-based, where a product is reduced for all customers or a specific customer is provided with a special offer. The creation of a customer-based special offer may require a vendor to track the buying behavior of a specific customer. Unfortunately, vendors are typically only able to track information received at their stores.

### SUMMARY OF THE INVENTION

The present invention discloses a system and method for providing a private offer for a customer. The private offer may be derived from the customer's behavior at different vendors' web sites.

In one aspect of the present invention a method is provided for creating private offers, the method including parsing at least a first computer-based document to identify at least one offer for either of a product and a service, maintaining the offer in a history of offers, detecting the activation of a private offer element within a second computer-based document, the private offer element being associated with either of a product and a service, determining, responsive to the activation, whether any of the offers in the history of offers meets at least one predefined criterion in predefined association with the private offer element, and applying at least one predefined modification to any of the offers in the history of meeting the predefined criterion, thereby resulting in a private offer.

In another aspect of the present invention the applying step includes reducing the price of the offer in accordance with a predefined price reduction function.

In another aspect of the present invention the determining step includes determining where the predefined criterion is a price interval between which the price of the offer falls.

In another aspect of the present invention the selecting step includes selecting one of the offers whose price is lowest within a price interval.

In another aspect of the present invention the method further includes verifying that the private offer meets a predefined verification criterion.

In another aspect of the present invention the method further includes modifying the private offer to meet the predefined verification criterion if the private offer does not meet the predefined verification criterion.

In another aspect of the present invention a method is provided for creating private offers, the method including parsing at least a first computer-based document to identify at least one offer for either of a product and a service, maintaining the offer in a history of offers, detecting the activation of a private offer element within a second computer-based document, the private offer element being associated with either of a product and a service, determining, responsive to the activation, whether any of the offers in the history of offers meets at least one predefined criterion in predefined association with the private offer element, and selecting from among any of the offers in the history meeting the predefined criterion, and at least one new offer not in the history, in accordance with a predefined policy, thereby resulting in a private offer.

In another aspect of the present invention the method further includes applying at least one predefined modification to the selected offer.

In another aspect of the present invention the applying step includes reducing the price of the offer in accordance with a predefined price reduction function.

In another aspect of the present invention the determining step includes determining where the predefined criterion is a price interval between which the price of the offer falls.

In another aspect of the present invention the selecting step includes selecting one of the offers whose price is lowest within a price interval.

In another aspect of the present invention the method further includes verifying that the private offer meets a predefined verification criterion.

In another aspect of the present invention the method further includes modifying the private offer to meet the predefined verification criterion if the private offer does not meet the predefined verification criterion.

In another aspect of the present invention a private offers system is provided including client-based means operative on a client to parse at least a first computer-based document to identify at least one offer for either of a product and a service, maintain the offer in a history of offers, detect the activation of a private offer element within a second computer-based document, the private offer element being associated with either of a product and a service, determine, responsive to the activation, whether any of the offers in the history of offers meets at least one predefined criterion in predefined association with the private offer element, apply at least one predefined modification to any of the offers in the history of meeting the predefined criterion, and transmit the modified offer to a server, and server-based means operative on the server to provide the second computer-based document to the client, provide the predefined criterion to the client, verify that the modified offer meets a predefined verification criterion, and transmit a verification of the modified offer to the client.

In another aspect of the present invention the client-based means is operative to apply step includes reducing the price of the offer in accordance with a predefined price reduction function.

In another aspect of the present invention the client-based means is operative to determine where the predefined criterion is a price interval between which the price of the offer falls.

In another aspect of the present invention the client-based means is operative to select one of the offers whose price is lowest within a price interval.

In another aspect of the present invention the server-based means is operative to verify that the private offer meets a predefined verification criterion.

In another aspect of the present invention the server-based means is operative to modify the private offer to meet the predefined verification criterion if the private offer does not meet the predefined verification criterion.

### BRIEF DESCRIPTION OF THE DRAWINGS

The present invention will be understood and appreciated more fully from the following detailed description taken in conjunction with the appended drawings in which:

FIG. 1A is a simplified flowchart illustration of a method for creating private offers, operative in accordance with a preferred embodiment of the present invention;

FIG. 1B is a simplified pictorial illustration of a system for creating private offers, constructed and operative in accordance with a preferred embodiment of the present invention;

FIG. 2 is a simplified pictorial illustration of a system for calculation of a private offer based on a customer history, constructed and operative in accordance with a preferred embodiment of the present invention;

FIG. 3 is a simplified pictorial illustration of a system for filtering a vendor's computer-based document to provide a private offer, constructed and operative in accordance with a preferred embodiment of the present invention;

FIG. 4 is a simplified pictorial illustration of a filtered vendor's document with a private offer, constructed and operative in accordance with a preferred embodiment of the present invention; and

FIG. 5 is a simplified flowchart illustration of a method for document parsing, operative in accordance with a preferred embodiment of the present invention.

### DETAILED DESCRIPTION OF PREFERRED EMBODIMENTS

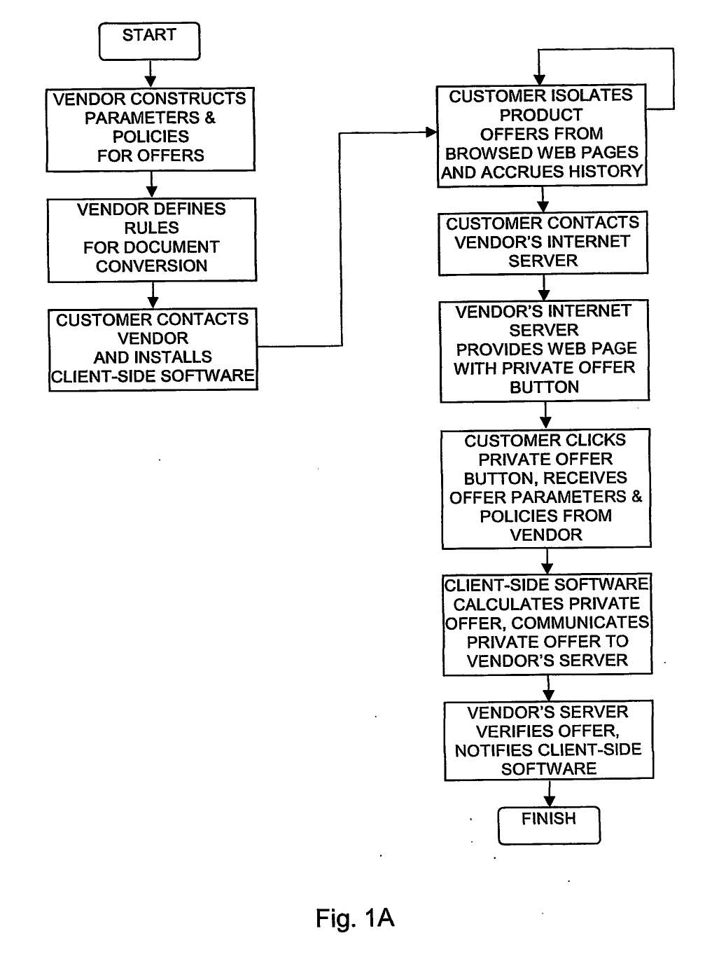

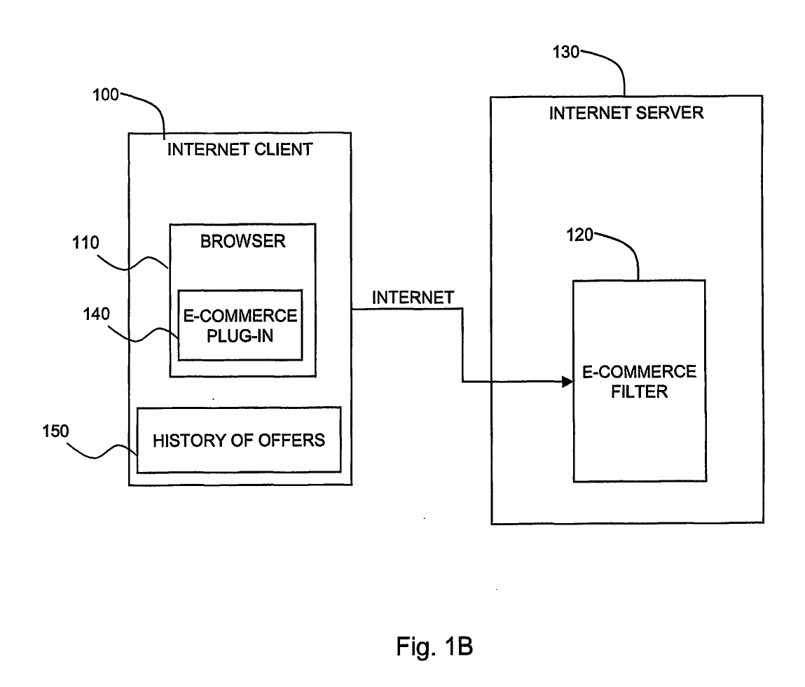

Reference is now made to FIG. 1A, which is a simplified flowchart illustration of a method for creating private offers, operative in accordance with a preferred embodiment of the present invention. In the method of FIG. 1A, a customer may employ a computer-based Internet browser to retrieve computer-based documents, such as HTML or XML-based web pages, from a vendor and render them for display. The vendor typically pre-loads a network server with documents that may be static or generated dynamically and which provide information regarding the product and services offered by the vendor. In addition, the vendor preferably prepares a set of parameters and policies associated with the products and services offered and a set of rules for document conversion, as described hereinbelow, to provide an environment for the creation of private offers. The parameters, policies, and rules are preferably created with the aid of a graphical user interface (GUI) designed to facilitate their utilization by a system for creation of private offers.

The vendor typically will request that the customer subscribe to a specialized service, such as a ‘private offers’ service. As part of the subscription process, the customer is preferably required to download and install an E-Commerce ‘plug-in’ for use with the customer's browser. The use of a plug-in is well known in the art of Internet browsers for providing additional functionality within the framework of the Internet browser, specific to the needs of an application programmer. Once the customer has installed the E-Commerce plug-in, the customer may take advantage of any private offers provided by the system as described hereinbelow with reference to FIG. 1B. These private offers may be provided by the e-commerce site at which the customer subscribed or at any other participating e-commerce site, preferably without need for further subscription.

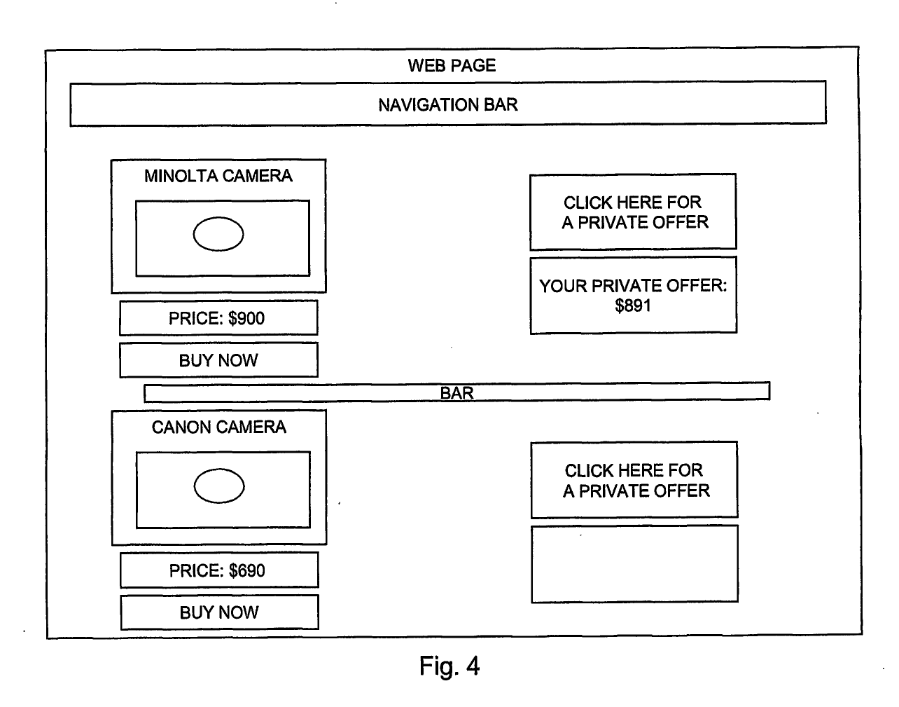

Reference is now made to FIG. 1B, which is a simplified illustration of a system for creating private offers, constructed and operative in accordance with a preferred embodiment of the present invention. In the system of FIG. 1B, a customer utilizing a client computer 100 typically employs a browser 110 to contact a vendor via a computer or telecommunications network, such as the Internet. Browser 110 preferably contacts a vendor's server 130, such as an IIS server commercially available from Microsoft Corporation of Redmond, Wash., U.S.A., to retrieve a document, such as an HTML document. Server 130 is preferably configured to employ a filter, such as an ISAPI filter, to filter all requests through an E-Commerce filter 120. E-commerce filter 120 may modify the requested document, and in particular may insert one or more ‘Private Offers’ buttons within the document as shown with reference to FIG. 4, with each ‘Private Offers’ button being associated with a particular product or service offered for sale within the requested document. Additionally or alternatively, the document may already contain one or more ‘Private Offers’ buttons. The document may then be retrieved and rendered by browser 110 for display. When the customer clicks a ‘Private Offers’ button associated with a particular product or service offered for sale, an E-Commerce plug-in 140, which may have been previously installed or which may be dynamically installed at this juncture, is activated. E-commerce plug-in 140 is preferably designed to contact E-Commerce filter 120, for example, over a SOAP communication channel, within a web services environment, and obtain parameters, policies, and rules for calculating a private offer in conjunction with a history of offers 150 as described hereinbelow.

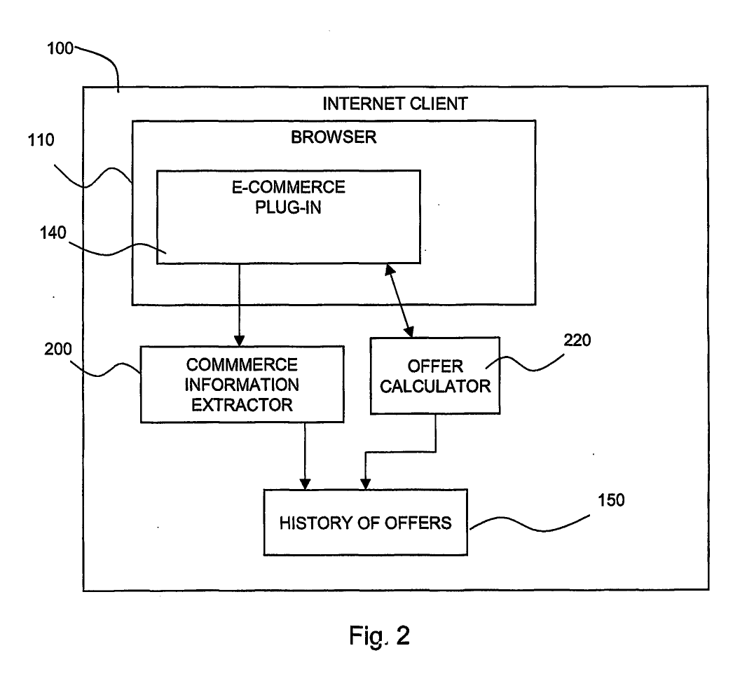

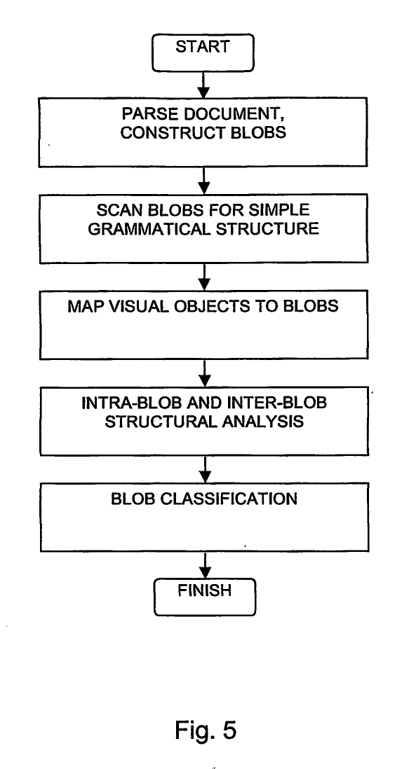

Reference is now made to FIG. 2, which is a simplified illustration of a system for calculation of a private offer based on a customer history, constructed and operative in accordance with a preferred embodiment of the present invention. In the system of FIG. 2, for each document retrieved by browser 110, a commerce information extractor 200 is preferably employed by E-Commerce plug-in 140 to extract information relating to one or more offers for products or services, hereinafter simply referred to as ‘offers,’ that may appear in the document. Commerce information extractor 200 preferably parses the retrieved document to extract such offers using the parsing method described hereinbelow with reference to FIG. 5 or any conventional parsing technique. Throughout the history of a customer's browsing of one or more vendors' web sites, E-Commerce plug-in 140 preferably identifies web sites encountered by browser 110 and stores extracted offers with vendor-specific information in the history of offers 150. Additionally, confirmed private offers provided to E-commerce plug-in 140 by Server 130 may also be stored in the history of offers 150. Offers may be stored as XML documents or in any document storage format.

By way of example, two offers extracted by commerce information extractor 200 from a document are presented hereinbelow:

<?xml version=“1.0”?>

<CIEOutput>

<offer>

<ID>2731131</ID>
<URL>www.Aces.com</URL>
<Product>Minolta Dimage G500</Product>

<Price>290.00</Price>
<Time>

31-Jan-04 02:00:32

</Time>

</offer>
<offer>

<ID>37134</ID>
<URL>www.amazon.com</URL>
<Product>REVIO KD-300Z Digital
Camera 3.34 Megapixel CCD</Product>
<Price>499.00</Price>
<Time>

2-Feb-03 22:00:32

</Time>

</offer>

</CIEOutput>

When a customer clicks a ‘Private Offers’ button associated with a product or service offer on a vendor's web page, the offer information associated with the ‘Private Offers’ button is provided to or captured by E-commerce plug-in 140 using any known means. E-commerce plug-in 140 then preferably contacts E-Commerce filter 120, for example, over a SOAP communication channel, preferably within a web services environment, indicating that the ‘Private Offers’ button for a particular product or service offer was clicked. E-Commerce filter 120 then sends predefined policies and parameters to E-commerce plug-in 140. Alternatively, the policies and parameters may be sent to E-commerce plug-in 140 as part of the web page downloaded from the vendor. E-commerce plug-in 140 then employs an offer calculator 210 to construct a private offer for the customer by applying the policies and parameters, typically to the information in the history of offers 150. For example, the policies and parameters may require that offer calculator 210 identify one or more offers stored in the history of offers 150 that match certain predefined criteria.

The parameters provided by E-Commerce filter 120 typically include a set of E-Commerce sites with which the vendor wishes to compete, and the policies typically include price information such as price intervals used in price comparisons between various offers. For example, price intervals preferably describe, with respect to a set of competitors, the interval of competitors' prices to consider for a particular product/service as a basis for calculating a reduction of the vendor's regular price for the same or different product/service. If a set of competitors' prices fall within the interval, then the lowest of the competitors' prices may be reduced by a predefined absolute amount or by a predefined relative amount (e.g., percentage of regular price). Preferably, the reduction of the regular price is further restricted to fall within an interval of prices predefined by the vendor.

The policies provided by E-Commerce filter 120 typically define a methodology, preferably via an XML document in declarative syntax, for offer calculator 210 to apply the parameters, such as to the offers stored in the history of offers 150. In the above example where two offers were extracted, a policy defined as an XML document may be defined as follows (comments are prefaced with ‘//’):

// define two competitors
// only offers from competitors are considered
from the history of offers
<Site> www.amazon.com </Site>
<Site> www.mysimon.com </Site>
// consider only offers from competitors that were
given 2 days before the present moment
// in time
<lowTime> 2 </lowTime> //
// reduce the competitors prices by 6%
<lowrelativeprice> 6 </lowrelativeprice>
// Keep the (reduced) minimum price to at least $200
<lowprice>200</lowprice>

This policy would be applied by searching the history of offers 150 to identify any offers that a) are from either www.amazon.com or www.mysimon.com and b) were encountered within the past two days. The matching offer price would be reduced by 6%, and would be offered by the current vendor provided that the reduced price does not fall below $200.

Thus, in this example, assuming that the calculation takes place on Feb. 3, 2004, at 08:00:00, the above policy will only match the second of the two extracted offers. The second offer, which matches the time specified, is reduced by 6% from $499.00 to $469.06, and since this offer is still higher then the minimum price of $200, the private offer meets the policy criteria.

Once the private offer is constructed, E-Commerce plug-in 140 communicates the private offer to E-Commerce filter 120, typically by direct communication between the Internet client and the E-Commerce filter without user interaction. Preferably the communication employs the SOAP protocol and is implemented within a web services environment. E-commerce filter 120 preferably verifies and confirms the private offer communicated by E-Commerce plug-in 140, and may propose a new private offer independent of or in conjunction with the private offer communicated by E-Commerce plug-in 140.

This entire procedure may be repeated one or more times for any particular product or for a multiplicity of products found on the vendor's document, resulting in one or more confirmed private offers. The customer may, between clicking ‘Private Offers’ buttons on the vendor's document, browse other documents of the same vendor's web site or browse other documents at other web sites. During such browsing the customer may obtain private offers for the same product or other products from the same vendor or other vendors, by clicking the ‘Private Offer’ button on these other documents.

The confirmed private offers are preferably presented to the customer in the form of additional HTML buttons on an HTML page, as depicted with reference to FIG. 4. It is appreciated that while the private offers are constructed based on a personal history of a particular customer, this personal information need not be transmitted nor communicated to any second party. Rather, the personal information that resides on the customer's computer is used to formulate the private offer, computed by the offer calculator, which is preferably the only information transmitted and communicated to the vendor's web site. This insures the continued security of the customer's personal information.

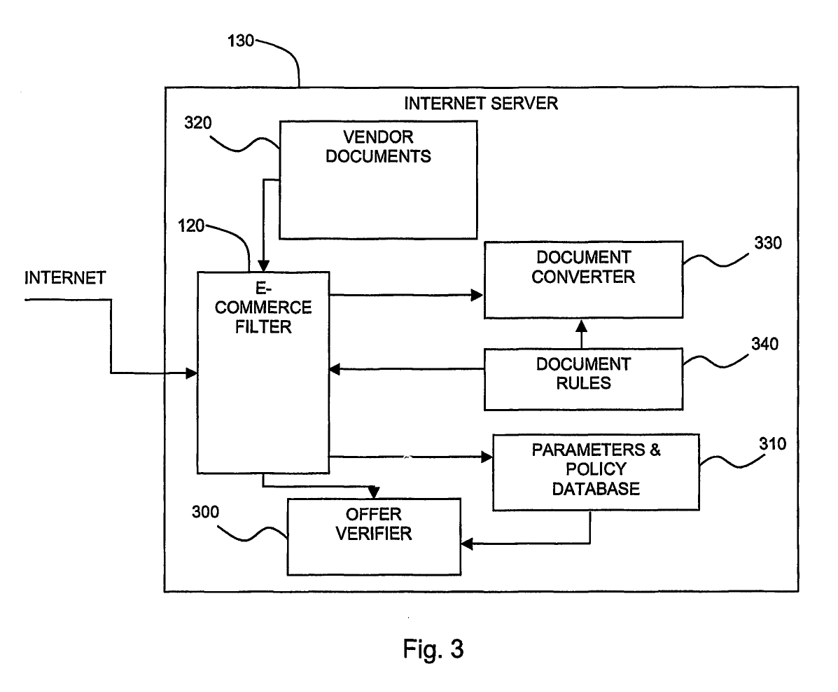

Reference is now made to FIG. 3, which is a simplified illustration of a system for filtering a vendor's document to provide a private offer, constructed and operative in accordance with a preferred embodiment of the present invention. In the system of FIG. 3, when a customer contacts a vendor's server 130, E-Commerce filter 120 receives the customer's original document request, and obtains the vendor's document corresponding to the request, from a vendor document repository 320, and sends the retrieved document to a document converter 330, which preferably employs document rules 340 to convert the vendor's original document into a document suitable for presenting private offers. For example, document converter 330 may insert a ‘Private Offers’ button within the document to enable the customer to initiate a request for a private offer for a particular product/service, shown in FIG. 4. The private offer is preferably calculated on Internet client 100 based on a set of parameters and policies obtained from the E-Commerce filter 120, for example over a SOAP communication channel, in a web services environment, constructed in response to the customer clicking the ‘Private Offers’ button located on the retrieved vendor's document. These parameters and policies are preferably obtained by the E-Commerce filter 120 from the parameters and policy database 310. Alternatively, E-Commerce filter 120 may incorporate the parameters and policies to be employed by the offer calculator 220, directly within the document prior to transmitting the document to the customer. In this fashion, the customer may be prompted to initiate a request for a private offer for a product or service based on a set of parameters and policies within the vendor's document. Either way, as described hereinabove, the actual private offer is preferably calculated on Internet client 100 based on the set of parameters and policies obtained from the E-Commerce filter 120.

A private offer, once calculated on Internet client 100, is preferably communicated to E-Commerce filter 120 for verification. E-Commerce filter 120 typically will employ offer verifier 300 to determine if the calculated offer falls within the permissible environment of calculated offers. Offer verifier 300 may accept and verify the calculated offer or may negate the previously calculated offer, in which case offer verifier 300 may propose and verify a new offer that may or may not be a function of the previously calculated offer. The offer verifier 300 operates according to parameters and policies similar to those employed by the offer calculator 220. These parameters and policies are preferably stored in the parameters and policy database 310. The policies typically include price information such as price intervals. For example, these price intervals define in which interval of prices should the price of the private offer sent for verification to the offer verifier fall. If the price of the private offer falls outside of this interval, it may be modified to fall within this interval. For example, it may be modified to be above the lower bound of the interval of prices if its price is smaller than that lower bound. The verified offer is preferably incorporated by E-Commerce filter 120 into a response document transmitted to the customer for confirmation of purchase. The commercial transaction typically will only begin once the customer confirms a purchase according to the verified private offer, at which point the customer's request to initiate an E-commerce transaction may be effected using conventional techniques.

Reference is now made to FIG. 5, which is a simplified flowchart illustration of a method for document parsing, operative in accordance with a preferred embodiment of the present invention. The method of FIG. 5 may be understood by way of example in which a single web page is retrieved from a single E-Commerce web site. The web page is typically in HTML or XML format in which structures may be defined by grouping syntactic or semantic tags. Each structure, referred to herein as a ‘blob’, may contain pertinent information describing an offer, such as a product name, shipment terms, a link to an image of the product, etc. The information describing an offer for a single product may span multiple blobs on the page. During parsing, all pertinent information related to the products offered on the web page is isolated and extracted. Visual objects found on the web page, such as images and text boxes, are preferably mapped to blobs as well. Blobs and their related visual objects that are determined not to contain pertinent information are removed from further processing.

In order to classify the extracted blobs, the content of each blob is scanned for predefined simple grammatical structures. Typical simple grammatical structures that determine if a blob contains an offer or part of an offer may include phrases such as “Regular price:”, “Discount:” and “You pay:” or currency symbols. Preferably, the structure of each blob and the relationships between structures of several blobs as a whole are also analyzed to determine the nature of the structure. For example, the structure may be found to indicate an offer where the number of occurrences of predefined offer-related phrases found in a blob meets a predefined threshold. For example, all of the different rows of a price table may be determined to each represent an offer, if they contain the same distribution of offer-related phrases among the different columns of the table. Conversely, the structure may be found to lack predefined offer-related attributes, indicating that the structure includes a textual segment, such as category descriptions, that can be ignored.

Finally, the blobs are classified and labeled accordingly. The offers identified may then be employed as described hereinabove with reference to FIG. 2.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for creating private offers, the method comprising:
parsing at least a first computer-based document to identify at least one offer for either of a product and a service;
maintaining said offer in a history of offers;
detecting the activation of a private offer element within a second computer-based document, said private offer element being associated with either of a product and a service;
determining, responsive to said activation, whether any of said offers in said history of offers meets at least one predefined criterion in predefined association with said private offer element; and
applying at least one predefined modification to any of said offers in said history of meeting said predefined criterion, thereby resulting in a private offer.

2. A method according to claim 1 wherein said applying step comprises reducing the price of said offer in accordance with a predefined price reduction function.

3. A method according to claim 1 wherein said determining step comprises determining where said predefined criterion is a price interval between which the price of said offer falls.

4. A method according to claim 1 wherein said selecting step comprises selecting one of said offers whose price is lowest within a price interval.

5. A method according to claim 1 and further comprising verifying that said private offer meets a predefined verification criterion.

6. A method according to claim 5 and further comprising modifying said private offer to meet said predefined verification criterion if said private offer does not meet said predefined verification criterion.

7. A method for creating private offers, the method comprising:
parsing at least a first computer-based document to identify at least one offer for either of a product and a service;
maintaining said offer in a history of offers;
detecting the activation of a private offer element within a second computer-based document, said private offer element being associated with either of a product and a service;
determining, responsive to said activation, whether any of said offers in said history of offers meets at least one predefined criterion in predefined association with said private offer element; and
selecting from among any of said offers in said history meeting said predefined criterion, and at least one new offer not in said history, in accordance with a predefined policy, thereby resulting in a private offer.

8. A method according to claim 7 and further comprising applying at least one predefined modification to said selected offer.

9. A method according to claim 8 wherein said applying step comprises reducing the price of said offer in accordance with a predefined price reduction function.

10. A method according to claim 7 wherein said determining step comprises determining where said predefined criterion is a price interval between which the price of said offer falls.

11. A method according to claim 7 wherein said selecting step comprises selecting one of said offers whose price is lowest within a price interval.

12. A method according to claim 7 and further comprising verifying that said private offer meets a predefined verification criterion.

13. A method according to claim 12 and further comprising modifying said private offer to meet said predefined verification criterion if said private offer does not meet said predefined verification criterion.

14. A private offers system comprising:
client-based means operative on a client to:
parse at least a first computer-based document to identify at least one offer for either of a product and a service;
maintain said offer in a history of offers;
detect the activation of a private offer element within a second computer-based document, said private offer element being associated with either of a product and a service;
determine, responsive to said activation, whether any of said offers in said history of offers meets at least one predefined criterion in predefined association with said private offer element;
apply at least one predefined modification to any of said offers in said history of meeting said predefined criterion; and
transmit said modified offer to a server; and
server-based means operative on said server to:
provide said second computer-based document to said client;
provide said predefined criterion to said client;
verify that said modified offer meets a predefined verification criterion; and
transmit a verification of said modified offer to said client.

15. A system according to claim 14 wherein said client-based means is operative to apply step comprises reducing the price of said offer in accordance with a predefined price reduction function.

16. A system according to claim 14 wherein said client-based means is operative to determine where said predefined criterion is a price interval between which the price of said offer falls.

17. A system according to claim 14 wherein said client-based means is operative to select one of said offers whose price is lowest within a price interval.

18. A system according to claim 14 wherein said server-based means is operative to verify that said private offer meets a predefined verification criterion.

19. A system according to claim 18 wherein said server-based means is operative to modify said private offer to meet said predefined verification criterion if said private offer does not meet said predefined verification criterion.
